(19) United States
(12) Patent Application Publication
(10) Pub. No.: US 2012/0205977 A1
(43) Pub. Date: Aug. 16, 2012

(54) POWER TRANSACTION SYSTEM AND TRANSACTION METHOD OF DISTRIBUTED POWER

(75) Inventors: Won Shik Shin, Gyeonggi-do (KR); Hakcheol Kim, Gyeonggi-do (KR); Yongdae Kim, Seoul (KR); Gwinam Park, Incheon (KR)

(73) Assignee: ILJIN ELECTRIC CO., LTD., Gyeonggi-do (KR)

(21) Appl. No.: 13/503,387

(22) PCT Filed: Dec. 23, 2009
(86) PCT No.: PCT/KR2009/007738

§ 371 Date: Apr. 23, 2012

(30) Foreign Application Priority Data
Nov. 16, 2009 (KR) 102009011528

(51) Int. Cl. H02J 4/00; G06Q 30/00; G08B 21/00

(52) U.S. Cl. 307/26; 340/635; 705/1.1

(57) ABSTRACT

Provided are a CDI electrode and a method for manufacturing a module using the same. A hybridized electrode manufactured by the manufacturing method of the present invention can manufacture a CDI electrode capable of increasing adsorption efficiency and rate of ions and selectively adsorbing cation and anion, thereby simply and inexpensively manufacturing the CDI electrode module without using a cation-exchange membrane and an anion-exchange membrane.

### TECHNICAL FIELD

Exemplary embodiments of the present invention relate to a power exchange system of distributed generation and a method thereof, and more particularly, to a power exchange system of distributed generation and a method thereof capable of selling power consumed and remaining from a group of consumers in power generated from a distributed power supply to a main grid side in real time or purchasing underpower from the main grid side in real time.

### BACKGROUND ART

Generally, many utilities such as electricity, gas, or the like, are distributed by several companies having a monopoly distribution right of specific geographical areas. Further, a system of a supply price of energy such as electricity gets stiff and makes a long-term contract in principle. For example, an electric charge is determined by government regulation every month, ever year.

Recently, a concept of the ‘distributed generation’ has been recognized. The distributed generation is to supply electricity at a place closer to a consumer rather than to an existing power plant, reduce power transmission conditions, and optimize efficiency of a power generation system. A distributed power plant may supply power to a single user or an overall grid, but may have much lower power than a centralized power plant, if any.

Many people are believed that the distributed generation changes a system of an electric grid in 21'st. The reason is that consumers have greater choice at the time of selecting generation, that is, the distributed generation and the transmission generation. A technology used for the distributed generation may be coupled with Internet to provide an opportunity to improve efficiency of power industries.

However, the distributed power supply connected to a main grid that is a commercial power network mainly uses new renewable energy (wind power, solar power, tidal power, wave power, or the like). The new renewable energy depends on a natural phenomenon. For example, wind that is a source of wind power generation does not blow at all times and thus, output power of a wind turbine is severely fluctuated. The solar power that is a source of solar power generation does not constantly output power from a solar panel according to time, cloud amount, precipitation, and snowfall.

In addition, power from the distributed power supply may be above or below consumption power or may according to the consumption patterns of consumers connected to the distributed power supply to consume power and the increase and decrease in the number of consumers.

### DISCLOSURE

### Technical Problem

An embodiment of the present invention is directed to a power exchange system of distributed generation and a method thereof capable of stably exchange power between a distributed power supply and a commercial power network.

### Technical Solution

A power exchange system of distributed power connected to a main grid of a commercial power supply to exchange power, including: a grid context analysis module configured to predictedly analyze power generation or power consumption of objects electrically connected to a distributed power supply in real time to generate exchange support information; an exchange module configured to control power exchange with the main grid based on the exchange support information; and a settlement module configured to control cost settlement according to an exchange of power with the main grid.

The power exchange system of distributed power may further include: a mobile monitoring module configured to sense an abnormal operation using a context signal received from a monitoring device disposed in the distribution power supply and transmit an alarm message to a mobile of a supervisor in a wired or a wireless manner at the time of sensing the abnormal operation.

The grid context analysis module may includes a real-time analysis module configured to analyze real-time power situation based on power generation information and consumer information; and a prediction module configured to predict future power generation and power consumption based on device status information, issue information, annual power generation, consumption data information, and weather information.

The power generation information may include: real-time power generation data and accumulated power generation amount data received from a passive power generator in the distributed power supplier; real-time charging voltage data, real-time discharging power data and accumulated discharging power data received from the battery in the distributed power supplier; and real-time power generation data and accumulated power generation amount data received from an active power generator in the distributed power supplier.

The device status information may include electrical status information of a passive power generator, a battery, and an active power generator in the distributed power supplier.

The electrical status information may include any one of voltage information, current information, phase information, and frequency information.

The exchange module may include: a first command processing unit configured to determine whether a sum of the expected power generation amount and a battery charging power amount of the passive power generator in the passive power generator is larger than the expected power consumption amount and if it is determined that a sum of the expected power generation amount and the battery charging power amount of the passive power generator is larger than the expected power consumption amount, processes a command transmitting it from the distributed power supply to the consumer group; and a second command processing unit configured to determine whether power generation cost of the active power generator is lower than purchasing cost from main grid purchasing cost by using purchase price information of the main grid if the sum of the expected power generation amount and the battery charging power amount of the passive power generator is smaller than the power consumption amount to process a command driving the active power generator if the power generation cost of the active power generator is lower than the main grid purchasing cost and process a command to purchase commercial power from the main grid if the power generation cost of the active power generator is higher than the main grid purchase cost.

The power exchange system of distributed power may further include: a passive power generation source configured to passively transform energy in the natural world into electric energy depending on a natural phenomenon; a battery electrically connected to the passive power generator and charged when the power generation of the passive power generator is excessive and discharged when the power generation of the passive power generator is insufficient to stabilize an output from the passive power generator; and an active power generator electrically connected to the passive power generator and supplementing power by generating power when the output from only the passive power generator and the battery does not meet power consumption.

The passive power generator may be at least any one of wind power generation, solar power generation, tidal power generation, and wave power generation.

The active power generator may be at least any one of bio energy power generation, water power generation, steam power generation, fuel cell power generation, and diesel power generation.

The mobile monitoring module may receive an image signal and a detection signal received from an image pick-up device and an invasion sensing sensor disposed in the distributed power supply, respectively, transmit an alarm message to a monitoring device in a wired or wireless manner at the time of sensing an abnormal operation from the detected image signal and the detection signal, and transmit various power data received to the grid context analysis module from the passive power generator, the battery, and the active power generator in the distributed power supply.

A power exchange method of distributed generation connected to a main grid of a commercial power supply to exchange power, including: a grid context analysis step of generating exchange support information by predictedly analyzing power generation or power consumption of objects electrically connected to a distributed power supply in real time; an exchange step of controlling power exchange with the main grid based on the exchange support information; and a settlement step of controlling cost settlement according to an exchange of power with the main grid.

The power exchange method of distributed generation may further include: a mobile monitoring step of sensing an abnormal operation using a context signal received from a monitoring device disposed in the distribution power supply and transmitting an alarm message to a mobile of a supervisor in a wired or a wireless manner at the time of sensing the abnormal operation.

The grid context analysis step may include: analyzing real-time power situation based on power generation information and consumer information; and predicting future power generation and power consumption based on device status information, issue information, annual power generation, consumption data information, and weather information.

The exchanging may include: a first command processing step of determining whether a sum of the expected power generation amount and a battery charging power amount of the passive power generator in the passive power generator is larger than the expected power consumption amount and if it is determined that a sum of the expected power generation amount and the battery charging power amount of the passive power generator is larger than the expected power consumption amount, processing a command transmitting it from the distributed power supply to the consumer group; and a second command processing step of determining whether power generation cost of the active power generator is lower than purchasing cost from main grid purchasing cost by using purchase price information of the main grid if the sum of the expected power generation amount and the battery charging power amount of the passive power generator is smaller than the power consumption amount to process a command driving the active power generator if the power generation cost of the active power generator is lower than the main grid purchasing cost and process a command to purchase commercial power from the main grid if the power generation cost of the active power generator is higher than the main grid purchase cost.

At the mobile monitoring step, an image signal and a detection signal received from an image pick-up device and an invasion sensing sensor disposed in the distributed power supply, respectively, may be received, an alarm message may be transmitted to a monitoring device in a wired or wireless manner at the time of sensing an abnormal operation from the detected image signal and the detection signal, and various power data received to the grid context analysis module from the passive power generator, the battery, and the active power generator in the distributed power supply may be transmitted to a monitoring device.

### Advantageous Effects

In accordance with the exemplary embodiments of the present invention, power can be stably exchanged between the distributed power supply and the commercial power network in real time.

### DESCRIPTION OF DRAWINGS

The above and other objects, features and advantages of the present invention will become apparent from the following description of preferred embodiments given in conjunction with the accompanying drawings, in which:

FIG. 1 is a conceptual diagram of a power exchange system of a distributed power supply in accordance with an embodiment of the present invention;

FIG. 2 is a conceptual diagram of a grid context analysis module 111 in accordance with an embodiment of the present invention;

FIG. 3 is a flow chart of an exchange module 113 in accordance with an embodiment of the present invention; and

FIG. 4 is a conceptual diagram of a use of a mobile monitoring module 114 in accordance with an embodiment of the present invention.

### DETAILED DESCRIPTION OF MAIN ELEMENTS

110: Operation/exchange system 111: Grid context analysis module

112: Settle module 113: Exchange module

114: Mobile monitoring module

120: Distributed power supply 121: Wind power generator

122: Battery 123: Bio energy power generator

130: Main grid 140: Consumer group A

150: Consumer group B 161, 162, 163: Distributed power supplier group

170: Power exchange

### Best Mode

Hereinafter, exemplary embodiments of the present invention will be described in detail with reference to the accompanying drawings. In the specification, in adding reference numerals to components throughout the drawings, it is to be noted that like reference numerals designate like components even though components are shown in different drawings. In addition, in the following description, a number of specific matters will be shown, which are provided only for assisting in the general understanding of the present invention. Therefore, it is obvious to those skilled in the art that the present invention may be practiced without these specific matters. Further, when it is determined that the detailed description of the known art related to the present invention may obscure the gist of the present invention, the detailed description thereof will be omitted.

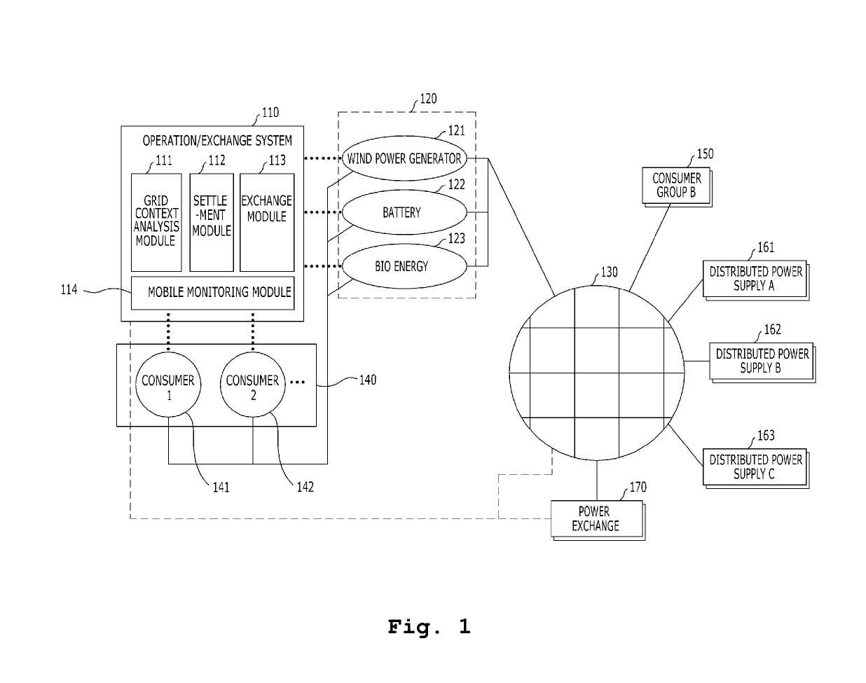

FIG. 1 is a conceptual diagram of a power exchange system of distributed generation in accordance with an exemplary embodiment of the present invention.

In accordance with the exemplary embodiment of the present invention, the power exchange system includes an operation/exchange system 110 including a context analysis module 111, a settlement module 112, an exchange module 113, and a mobile monitoring module 114, a distributed power supply 120 including a wind power generator 121, a, a battery 122, and a bio energy generator 123, a main grid 130, a consumer group A 140 supplied with power from the distributed power supply 120, a consumer group B 150 supplied with power from the main grid 130, distributed power supply groups 161, 162, and 164 connected to the main grid to receive power, and a power exchange 170 serving to exchange power.

Although not shown, the wind power generator 121 includes a wind turbine, a battery capable of calibrating output that is severely fluctuated from the wind turbine, and an inverter converting and outputting output from the battery into a commercial frequency. In accordance with another embodiment of the present invention, solar power generation, tidal power, tidal current, wave power, or the like, instead of the wind power generator, may be used, which are collectively referred to as a passive power generator.

The battery 122 is charged when an output from the wind power generator 121 is excessive and is discharged when an output from the wind power generator 121 is insufficient, thereby making it possible to more stabilize the output from the wind power generator 121.

The bio energy generator 123 generates power to supplement underpower when only the output from the wind power generator 121 and the battery 122 does not meet power consumption of consumers. In accordance with another embodiment of the present invention, fuel cell power generation, steam power generation, water power generation, diesel power generation, or the like, instead of the bio energy generator, may be used, which are collectively referred to as an active power generator.

The main grid 130 means a commercial power network.

The distributed power supply groups 161, 162, and 163 mean various distributed power supplies that are connected to the main grid to receive power.

The operation/exchange system 110 may periodically receive real-time power generation data, accumulated generation amount data, and context signals (image signal, sensor detection signal, or the like) data from the wind power generator 121 using an RS-485 communication type. The operation/exchange system 110 may periodically receive real-time charging voltage data, real-time discharge power data, accumulated discharge generation data, context signals (image signal, sensor detection signal, or the like) data from the battery 122 by the RS-485 communication type. In addition, the operation/exchange system 110 may periodically receive real-time power generation data, accumulated power generation amount data, and context signals (image signal, sensor detection signal, or the like) data from the bio energy power generator 123 by the RS-485 communication type.

The operation/exchange system 110 may periodically receive real-time power consumption data and accumulated power consumption data from individual consumers 141, 142, . . . in the consumer group A 140 by the RS-485 communication type.

The operation/exchange system 110 may transmit and receive power price information, power exchange information, or the like, to and from the power exchange 170. In this case, in accordance with the embodiment of the present invention, the operation/exchange system 110 may directly communicate with the power exchange 170 by the RS-485 communication type. In another exemplary embodiment of the present invention, the operation/exchange system 110 may communicate with the power exchange 170 through the main grid 130 by a power line communication type.

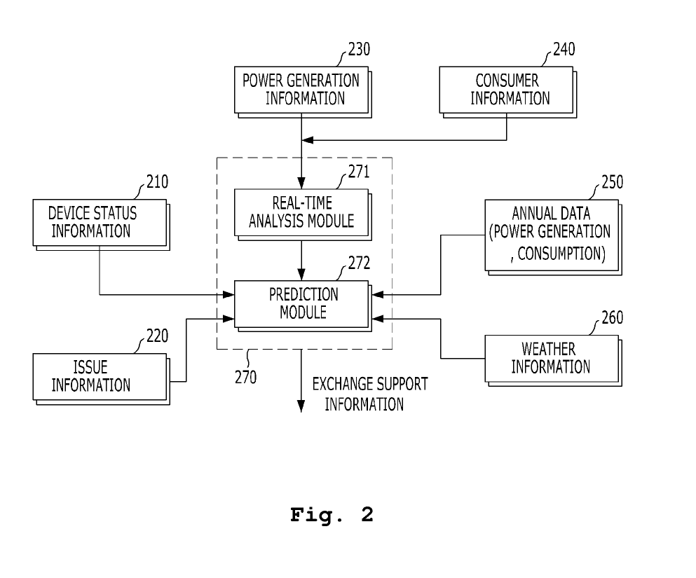

FIG. 2 is a conceptual diagram of a grid context analysis module in accordance with the embodiment of the present invention.

The grid context analysis module 111 in accordance with the embodiment of the present invention generates exchange support information by using a real-time analysis module 271 that analyzes real-time power situation based on power generation information 230 and consumer information 240 and a prediction module 272 that predicts future power generation and power consumption based on device status information 210, issue information such as events, news, or the like, annul power generation and consumption data information 250, and daily, weekly, monthly, and annually weather information 260.

The real-time analysis module 271 analyzes supply and demand situation between power generation and power consumption in real time based on the power generation information 230 and the consumer information 240.

Here, the power generation information 230 may be the real-time power generation data and the accumulated power generation amount data received from the wind power generator 121, the real-time charging voltage data, the real-time discharging power data, and the accumulated discharging power amount data received from the battery 122, and the real-time power generation data and the accumulated power generation amount data received from the bio energy generator 123, or the like.

Further, the consumer information 240 may be the power consumption data, the accumulated power consumption amount data, or the like, that are received from the individual consumers 141, 142, . . . in the consumer group A 140.

The prediction module 272 predicts power that can be generated in the future based on the issue information 220, such as events, news, or the like, the annual power generation and consumption data information 250, and the daily, weekly, monthly, annually weather information 260 and predicts power that can be generated in the future based on the device status information 210.

The device status information 210 includes various status information of the wind power generator 121, the battery 122, and the bio energy power generator 123 within the distributed power supply 120. Here, various status information may be, for example, electrical signals such as a voltage value, a current value, a phase, a frequency, or the like, detected by a PT, a CT, a phase sensor, and a frequency sensor that are mounted in the wind power generator 121 and the bio energy power generator 123, respectively, temperature, wind velocity data detected by a temperature sensor and a wind velocity sensor that are mounted at a predetermined position of the wind power source 121, and a voltage value, a current value, temperature, a water level data detected by the PT, the CT, the temperature sensor, a water level sensor that are mounted in the battery 122.

The prediction module 272 determines a deterioration degree of the device, the expected time to replace the device, or the like, or the like, by using the device status information 210, thereby making it possible to predict power that can be generated in the future.

The prediction module 272 uses the issue information 220 such as events, news, or the like, thereby making it possible to predict the sudden increase or the sudden decrease of power consumption due to, for example, unexpected events, generation of news.

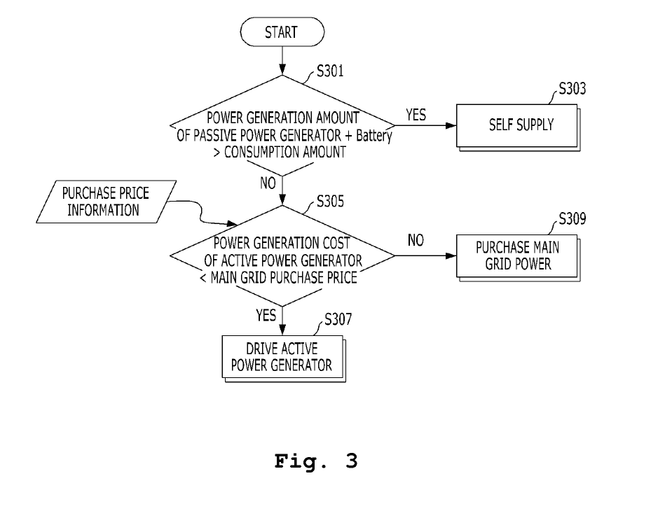

FIG. 3 is a flow chart of the exchange module 113 in accordance with the embodiment of the present invention. The exchange module 113 determines whether a sum of the expected power generation amount and a battery charging power amount of the passive power generator is larger than the expected power consumption amount (S301) and if the sum of the expected power generation amount and the battery charging power amount of the passive power generator is larger than the expected power consumption amount to process a command transmitting it from the distributed power supply to the consumer group (S303).

However, the exchange module determines whether power generation cost of the active power generator is lower than the purchasing cost from main grid purchasing cost by using purchase price information if a sum of the expected power generation amount of the passive power generator and the battery charging power amount is smaller than the power consumption amount (S305), processes a command driving the active power generator if the power generation cost of the active power generator is lower than the main grid purchasing cost (S307), and process a command to purchase commercial power from the main grid if the power generation cost of the active power generator is higher than the main grid purchase cost (S309).

The settlement module 112 in accordance with the embodiment of the present invention processes a command to sale the power generation of the distributed power supply to the main grid, processes a command to purchase the commercial power of the main grid from the distributed power supply, and processes a command to pay an uncollected amount or a payment that has not yet been received, or the like.

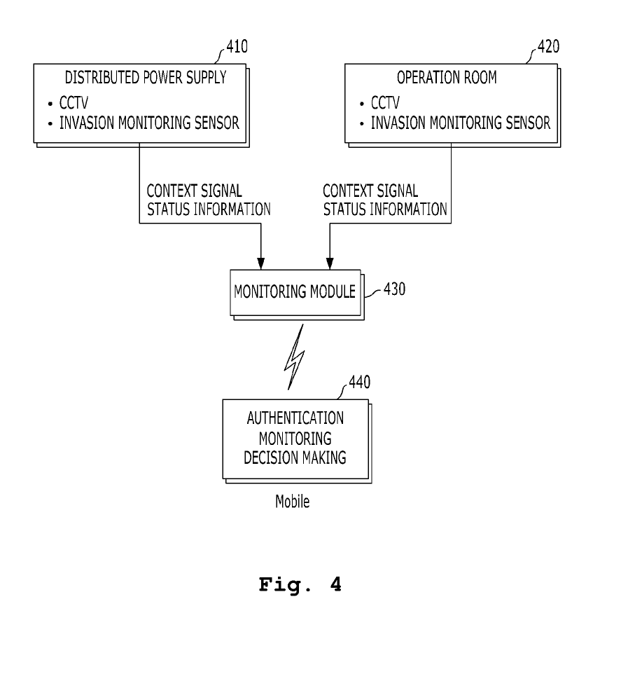

FIG. 4 is a conceptual diagram of a use of a mobile monitoring module 114 in accordance with the embodiment of the present invention.

A mobile monitoring module 430 transmits various power data received in a real-time analysis module 271 and a prediction module 272 of the grid context analysis module 111 from the wind power generator 121, the battery 122, and the bio energy power generator 123 to a supervisor mobile.

In addition, the mobile monitoring module 430 receives context signals, such as an image signal from a CCTV disposed around a distributed power supplier 410, that is, the wind power generator 121, the battery 122, and the bio energy power generator 123, respectively, to perform the photographing, a detection signal from an invasion sensing sensor, or the like, and transmits an alarm message at the time of sensing an abnormal operation to a mobile of a supervisor in a wired or wireless manner.

Further, the mobile monitoring module 430 receives the context signals such as the image signal from the CCTV and the detection signal from the invasion sensing sensor that are disposed outside and inside an operation room 420 in which the operation/exchange system is installed and transmits the alarm message to the mobile of the supervisor in a wired or wireless manner when the abnormal operation of the device is sensed.

The mobile monitoring module 430 transmits the context information and the status information to the mobile 440 of the supervisor and the supervisor may confirm the monitoring information transmitted after the authentication and perform decision making.

As described above, while the present invention has been described in connection with the exemplary embodiments, modifications and variations can be made without departing from the scope of the present invention Accordingly, the scope of the present invention is not construed as being limited to the described embodiments but is defined by the appended claims as well as equivalents thereto.

What is claimed is:

1. A power exchange system of distributed power connected to a main grid of a commercial power supply to exchange power, comprising:
a grid context analysis module configured to predictedly analyze power generation or power consumption of objects electrically connected to a distributed power supply in real time to generate exchange support information;
an exchange module configured to control power exchange with the main grid based on the exchange support information; and
a settlement module configured to control cost settlement according to an exchange of power with the main grid.

2. The system of claim 1, further comprising: a mobile monitoring module configured to sense an abnormal operation using a context signal received from a monitoring device disposed in the distribution power supply and transmit an alarm message to a mobile of a supervisor in a wired or a wireless manner at the time of sensing the abnormal operation.

3. The system of claim 1, wherein the grid context analysis module includes:
a real-time analysis module configured to analyze real-time power situation based on power generation information and consumer information; and
a prediction module configured to predict future power generation and power consumption based on device status information, issue information, annual power generation, consumption data information, and weather information.

4. The system of claim 3, wherein the power generation information includes:
real-time power generation data and accumulated power generation amount data received from a passive power generator in the distributed power supplier;
real-time charging voltage data, real-time discharging power data and accumulated discharging power data received from the battery in the distributed power supplier; and
real-time power generation data and accumulated power generation amount data received from an active power generator in the distributed power supplier.

5. The system of claim 3, wherein the device status information includes electrical status information of a passive power generator, a battery, and an active power generator in the distributed power supplier.

6. The system of claim 5, wherein the electrical status information includes any one of voltage information, current information, phase information, and frequency information.

7. The system of claim 1, wherein the exchange module includes:
a first command processing unit configured to determine whether a sum of the expected power generation amount and a battery charging power amount of the passive power generator in the passive power generator is larger than the expected power consumption amount and if it is determined that a sum of the expected power generation amount and the battery charging power amount of the passive power generator is larger than the expected power consumption amount, processes a command transmitting it from the distributed power supply to the consumer group; and
a second command processing unit configured to determine whether power generation cost of the active power generator is lower than purchasing cost from main grid purchasing cost by using purchase price information of the main grid if the sum of the expected power generation amount and the battery charging power amount of the passive power generator is smaller than the power consumption amount to process a command driving the active power generator if the power generation cost of the active power generator is lower than the main grid purchasing cost and process a command to purchase commercial power from the main grid if the power generation cost of the active power generator is higher than the main grid purchase cost.

8. The system of claim 1, further comprising:
a passive power generation source configured to passively transform energy in the natural world into electric energy depending on a natural phenomenon;
a battery electrically connected to the passive power generator and charged when the power generation of the passive power generator is excessive and discharged when the power generation of the passive power generator is insufficient to stabilize an output from the passive power generator; and
an active power generator electrically connected to the passive power generator and supplementing power by generating power when the output from only the passive power generator and the battery does not meet power consumption.

9. The system of claim 8, wherein the passive power generator is at least any one of wind power generation, solar power generation, tidal power generation, and wave power generation.

10. The system of claim 8, wherein the active power generator is at least any one of bio energy power generation, water power generation, steam power generation, fuel cell power generation, and diesel power generation.

11. The system of claim 2, wherein the mobile monitoring module receives an image signal and a detection signal received from an image pick-up device and an invasion sensing sensor disposed in the distributed power supply, respectively, transmits an alarm message to a monitoring device in a wired or wireless manner at the time of sensing an abnormal operation from the detected image signal and the detection signal, and transmits various power data received to the grid context analysis module from the passive power generator, the battery, and the active power generator in the distributed power supply.

12. A power exchange method of distributed generation connected to a main grid of a commercial power supply to exchange power, comprising:
a grid context analysis step of generating exchange support information by predictedly analyzing power generation or power consumption of objects electrically connected to a distributed power supply in real time;
an exchange step of controlling power exchange with the main grid based on the exchange support information; and
a settlement step of controlling cost settlement according to an exchange of power with the main grid.

13. The method of claim 12, further comprising: a mobile monitoring step of sensing an abnormal operation using a context signal received from a monitoring device disposed in the distribution power supply and transmitting an alarm message to a mobile of a supervisor in a wired or a wireless manner at the time of sensing the abnormal operation.

14. The method of claim 12, wherein the grid context analysis step includes:
analyzing real-time power situation based on power generation information and consumer information; and
predicting future power generation and power consumption based on device status information, issue information, annual power generation, consumption data information, and weather information.

15. The method of claim 12, wherein the exchanging includes:
a first command processing step of determining whether a sum of the expected power generation amount and a battery charging power amount of the passive power generator in the passive power generator is larger than the expected power consumption amount and if it is determined that a sum of the expected power generation amount and the battery charging power amount of the passive power generator is larger than the expected power consumption amount, processing a command transmitting it from the distributed power supply to the consumer group; and
a second command processing step of determining whether power generation cost of the active power generator is lower than purchasing cost from main grid purchasing cost by using purchase price information of the main grid if the sum of the expected power generation amount and the battery charging power amount of the passive power generator is smaller than the power consumption amount to process a command driving the active power generator if the power generation cost of the active power generator is lower than the main grid purchasing cost and process a command to purchase commercial power from the main grid if the power generation cost of the active power generator is higher than the main grid purchase cost.

16. The method of claim 13, wherein at the mobile monitoring step, an image signal and a detection signal received from an image pick-up device and an invasion sensing sensor disposed in the distributed power supply, respectively, are received, an alarm message is transmitted to a monitoring device in a wired or wireless manner at the time of sensing an abnormal operation from the detected image signal and the detection signal, and various power data received to the grid context analysis module from the passive power generator, the battery, and the active power generator in the distributed power supply are transmitted to a monitoring device.
